(19) United States
(12) Patent Application Publication
(10) Pub. No.: US 2025/0362500 A1
(43) Pub. Date: Nov. 27, 2025

(54) HYBRID ANSWERS ON A HEAD-WEARABLE DISPLAY USING AN EDGE LARGE LANGUAGE MODEL AND EXTENDED LARGE LANGUAGE MODEL

(71) Applicant: GOOGLE LLC, Mountain View, CA (US)

(72) Inventors: Dongeek Shin, San Jose, CA (US); Sinan Hersek, Seattle, WA (US)

(21) Appl. No.: 18/673,216

(22) Filed: May 23, 2024

(51) Int. Cl. G02B 27/01; G06F 40/284

(52) U.S. Cl. CPC G02B 27/017; G06F 40/284

(57) ABSTRACT

To reduce the time needed to display an answer to a prompt received at a head-wearable device (HWD), the HWD includes an edge large-language (LLM) model implemented at the HWD. Based on the prompt, the HWD generates tokens and edge answers using the edge LLM. In response to one or more of the tokens being a delegation token and concurrently with displaying the edge answer, the HWD transmits token embeddings of the tokens to a server implementing an extended LLM. The HMD then displays a hybrid answer including the edge answer and the extended answer.

### BACKGROUND

Wearable devices often include input devices, such as microphones, touchscreens, keyboards, and the like, configured to receive user inputs representing inquiries, commands, and directions. To provide a response to these inquiries, commands, and directions, such wearable devices transmit data representing the received user inputs to servers implementing a large language model (LLM) that includes multiple attention layers. For each attention layer of the implemented LLM, the servers generate tokens based on the received user inputs and the parameters of the LLM with each of these generated tokens representing a portion of a response. The servers then combine these generated tokens to produce a response to the inquiry, command, or direction indicated by the received user inputs. After producing this response, the servers transmit the response back to the wearable device which outputs the response to the user.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of an extended reality (XR) system configured to provide a hybrid answer to a user based on an edge large language model (LLM) and an extended LLM, in accordance with some embodiments.

FIG. 2 is a block diagram of an example attention layer for an LLM, in accordance with some embodiments.

FIG. 3 is a flow diagram of an example operation for providing a hybrid answer using an edge LLM and extended LLM, in accordance with embodiments.

FIG. 4 is a block diagram of an example operation for providing an extended LLM input to an extended LLM, in accordance with embodiments.

FIG. 5 is an example timing diagram for providing an answer to a hybrid user using an edge LLM and an extended LLM, in accordance with embodiments.

FIG. 6 is a flow diagram of an example method for producing a hybrid answer using an edge LLM and extended LLM, in accordance with embodiments.

### DETAILED DESCRIPTION

Systems and techniques disclosed herein are directed to extended reality (XR) systems that include a HWD configured to provide answers to user prompts (e.g., user questions). To this end, the HWD includes input devices such as microphones, eye-gaze tracking sensors, and the like configured to receive user inputs. For example, these input devices are configured to receive a prompt from a user in the form of speech, text, or both. To provide the user with an answer to the received prompt, the HWD transmits data indicating the prompt to one or more servers via a network. Based on receiving such data, the servers then generate a response to the prompt using a large language model (LLM). This LLM, for example, includes multiple attention layers each having a prefill phase and a decoding phase. During the prefill phase of each attention layer, the servers first generate a key-value cache and first token based on a corresponding section of the prompt. For example, during a prefill phase, the servers, based on a corresponding section of the prompt, determine one or more queries (e.g., representing data indicated in the question or prompt), one or more keys (e.g., description of content), and one or more values (e.g., content matching one or more queries) based on the parameters (e.g., weights) of the LLM (e.g., the parameters established by training the LLM). The servers then generate a key-value cache including the determined keys and values and a first token based on the determined queries, keys, and values. This first token, for example, includes data representing at least a portion of an answer such as a letter, symbol (e.g., punctuation, character), syllable, word, or the like.

Further, during the decode phase of each attention layer, the servers sequentially generate tokens based on the first token and the key-value cache until an end token is generated, a predetermined condition has been met (e.g., predetermined length of response, predetermined time elapsed), or both. For example, for the first token, the servers determine a query, key, and value and update the KV catch based on the determined key and value. Using the updated KV catch, the servers then determine a first matrix including keys and a second matrix including values. The servers next perform multiple matrix multiplication operations using the query, first matrix, and second matrix to determine a second token. After generating the second token, the servers next generate a third token by determining a query, key, and value for the second token and then updating the KV catch based on the determined key and value. Using the updated KV catch, the servers determine another first matrix including keys and another second matrix including values, and then perform matrix multiplication operations based on the query, first matrix, and second matrix to produce a third token. During the decode phase of a layer, the servers continue to sequentially generate tokens in this way until an end token is generated, a predetermined condition has been met, or both. The servers then combine the tokens generated by each attention layer of the LLM to determine an answer (e.g., data representing a text response to the received prompt) and provide the answer back to the HWD via the network.

Based on receiving the answer from the servers, the HWD then outputs the answer (e.g., the text response to the received prompt) as text on a display, as audio, or both. As an example, the HWD generates light representative of the text indicated in the answer and a lightguide of the HWD is configured to directs this light representative of the text indicated in the answer toward the eye of a user such that the text indicated in the answer is presented to the user in a real-world environment visible through the HWD (e.g., through the lenses of the HWD). However, due to the time needed for the servers to generate the answer using the LLM, a noticeable time (e.g., query time) from when the user inputs the prompt to when the answer is output by the HWD is likely to occur. This noticeable query time interrupts the interactivity between the HWD and the user which negatively impacts user experience and the desired use of the device.

As such, systems and techniques disclosed herein are directed to reducing the query time from when a user prompt is received to when an answer is output by the HWD by using a first LLM (e.g., edge LLM) implemented by the HWD. To this end, an XR system includes an HWD configured to implement a first LLM that is smaller in size (e.g., has a smaller memory footprint) than a second LLM (e.g., extended LLM) implemented on one or more servers connected to the HWD via a network. For example, the first LLM includes fewer parameters, fewer attention layers, or both than the second LLM implemented on the servers. Based on receiving a prompt from a user and using the first LLM, the HWD generates an edge response based on the prompt. As an example, each attention layer of the first LLM is configured to receive an input data structure (e.g., matrix) including values representing at least a portion of the received prompt (e.g., representing the content and position of one or more tokens of the prompt). For each prefill phase of the attention layers of the first LLM, the HWD generates a key-value cache and first token based on a corresponding input data structure. Based on the first token, the HWD, for the decode phase of each attention layer, sequentially generates additional tokens until an end token is generated, a predetermined condition is met, or both. Additionally, during the prefill and decode phases of each attention layer, the HWD is configured to generate one or more delegation tokens based on the parameters of the first LLM (e.g., based on the training data of the first LLM). Such delegation tokens, for example, include data indicating that a second answer (e.g., extended answer) is to be generated for the prompt. For example, the one or more delegation tokens are a token different from an end token (e.g., an end-of-sentence (EOS) token). The delegation token may be output in addition to an end token, e.g., after the end token. After the HWD has completed generating tokens for each layer, the HWD then combines the generated tokens to generate a first answer (e.g., edge answer) which includes text to be output to the user. For example, the HWD displays the text indicated in this first answer to the user.

Further, while the HWD is generating and displaying the first answer to the user, the HWD is configured to determine whether one or more delegation tokens were generated during the prefill or decode phases of the attention layers. That is to say, the HWD determines whether the generated plurality of tokens indicate a second answer is to be generated. Based on one or more delegation tokens being generated, the HWD then transmits data representing the prompt, data representing the one or more generated tokens, or both to the servers. As an example, based on one or more delegation tokens being generated, the HWD transmits embeddings (e.g., vectorized data) representing the tokens generated for the attention layers of the first LLM. In response to receiving such data representing the prompt, one or more generated tokens, or both, the servers then generate a second answer using the second LLM. For example, based on receiving one or more embeddings, the servers are configured to provide respective embeddings to each attention layer of the second LLM. For a prefill phase of each attention of the second LLM, the servers then generate a key-value cache and first token based on a corresponding embedding. Additionally, for a decode phase of each attention layer, the servers then sequentially generate tokens based on the key-value catch and first token until an end token is generated, a predetermined condition is met, or both. After the servers have generated the tokens for each attention layer, the servers then combine the generated tokens to produce a second answer. The servers then provide the second answer to the HWD which outputs (e.g., displays) the second answer to the user with the first answer. That is to say, the HWD outputs a hybrid answer that includes both the first answer generated by the HWD and a second answer generated by the servers.

Because the first LLM on the HWD is smaller than the second LLM at the servers, the first LLM is enabled to generate the first answer in less time than it would take for the second LLM to generate an answer. As such, the time (e.g., query time) from when the user inputs the prompt to when an answer (e.g., the first answer) is displayed to the user is reduced, helping improve user experience. Further, due to the first LLM being smaller than the second LLM, the first answer is likely to be less accurate, shorter, or both than a second answer generated by the second LLM. As such, when the second LLM determines that a second answer is needed in addition to the first answer based on the training (e.g., parameters) of the first LLM, the HWD produces a delegation token indicating that a second answer is to be generated. Based on such a delegation token, the HWD then provides the embeddings of the attention layers of the first LLM to the second LLM while the first answer is output to the user. Because such embeddings are provided to the second LLM, the embeddings do need to again be generated by the second LLM, helping to reduce the time needed for the second LLM to generate an extended answer. In this way, the HWD is enabled to provide a first answer (e.g., edge answer) while the servers generate a second answer (e.g., extended answer), helping provide a first answer to the user more quickly. Additionally, the HWD, via the delegation tokens and embeddings, is enabled to help reduce the query time in instances where a second answer is desirable or required by reducing the time needed by the servers to generate the second answer. As such, the accuracy of the hybrid answer (e.g., first answer and second answer) presented by the HWD to the user is improved while also reducing the query time via the first answer and embeddings, helping to improve user experience.

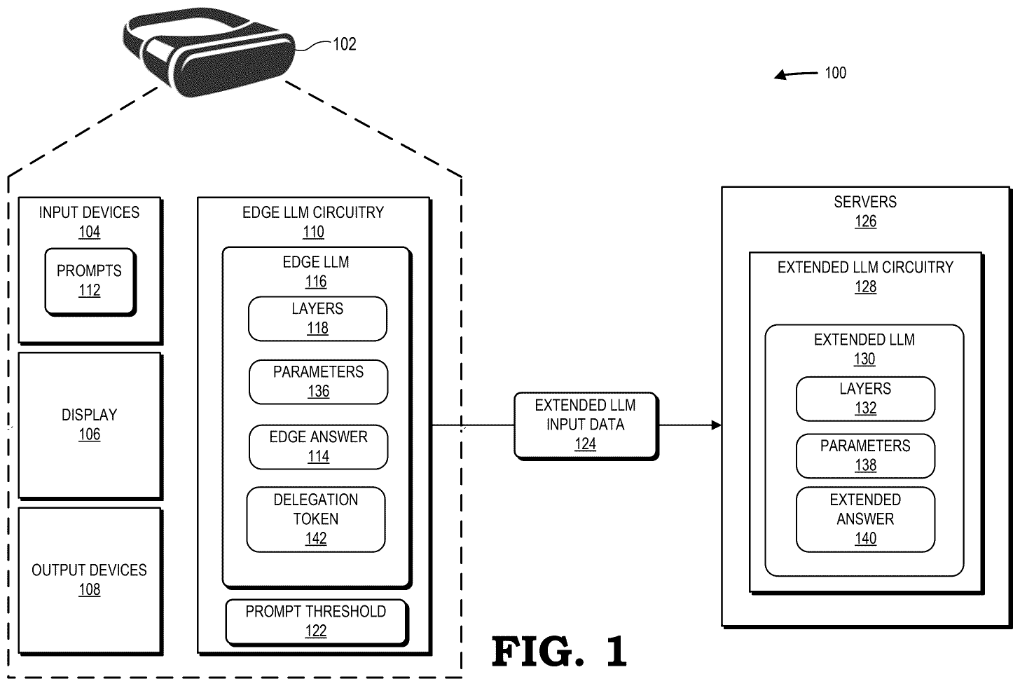

Referring now to FIG. 1, an XR system 100 configured to generate hybrid answers using an edge LLM and extended LLM is presented, in accordance with embodiments. XR system 100 includes an HWD 102 configured to output one or more answers to a user based on one or more prompts 112. For example, in embodiments, HWD 102 includes one or more input devices 104 such as microphones, eye gaze sensors, keyboards (e.g., virtual keyboards), and the like configured to receive one or more user inputs (e.g., user speech, text). According to some embodiments, one or more user inputs received by input devices 104 indicate one or more prompts 112 each including one or more questions, directions, instructions, or the like. As an example, in some embodiments, a microphone of input devices 104 is configured to receive user speech that indicates one or more prompts 112 each including a question (e.g., “what is the capital of Spain?,” “where is the nearest gas station?”, “how do I get home?”) As another example, according to some embodiments, a virtual keyboard of input devices 104 is configured to receive user inputs (e.g., via an eye gaze sensors) that indicate a prompt 112 including an instruction (e.g., “tell me a joke,” “show me a poem,” “write a story”). To provide an answer to these prompts 112 (e.g., text answering or responding to a prompt 112), HWD 102 uses an edge LLM 116 implemented on the HWD 102 (also referred to herein as a “first LLM”), an extended LLM 130 implemented at one or servers 126 communicatively coupled to the HWD 102 via a network (also referred to herein as a “second LLM”), or both.

According to embodiments, HWD 102 includes an edge LLM circuitry 110 (e.g., a large language model circuitry) configured to implement an edge LLM 116 and including one or more processors, processor cores, memories, caches, and the like. Such an edge LLM 116 includes a trained LLM with a number of parameters 136 that indicate the weights applied by one or more attention layers 118 of the edge LLM 116 to generate an answer (e.g., edge answer 114) based on a prompt 112. In embodiments, to determine such parameters 136, a processing system, such as the servers 126, is configured to train an LLM using a first set of training data (e.g., edge training data). Based on this first set of training data, the edge LLM 116 determines the parameters 136 used to generate one or more edge answers 114 from one or more prompts 112. Further, in embodiments, one or more servers 126 have an extended LLM circuitry 128 that is configured to implement extended LLM 130 and that includes one or more processors, processor cores, memories, caches, and the like. This extended LLM 130 includes a number of parameters 138 that indicate the weights applied by one or more attention layers 132 of the extended LLM 130 to generate an answer (e.g., extended answer 140) based on a prompt 112 or other input data. These parameters 138, for example, are based on a second set of training data (e.g., extended training data) used to train the extended LLM 130. As an example, servers 126 train an LLM using the second set of training data so as to determine the parameters 138.

In some embodiments, the edge LLM 116 implemented by the HWD 102 (e.g., first LLM) has a smaller memory footprint than the extended LLM 130 implemented by the servers 126 (e.g., second LLM). That is to say, the edge LLM 116 is smaller than the extended LLM 130. As an example, the edge LLM 116 includes fewer parameters 136, attention layers 118, or both compared to the extended LLM 130 (i.e., the extended LLM 130 has more parameters 138, attention layers 132, or both than the edge LLM 116). Due to the edge LLM 116 including fewer parameters 136, attention layers 118, or both than the extended LLM 130, the edge LLM 116 requires less memory to operate than the extended LLM 130, allowing the edge LLM 116 to be implemented on the HWD 102 which includes fewer or slower processing resources (e.g., memory, processor cores, processing speeds) than the servers 126 implementing the extended LLM 130. Further, because the edge LLM 116 is smaller than the extended LLM 130, the edge LLM 116 is enabled to generate an answer (e.g., edge answer 114) to a prompt 112 in less time than it would take for the extended LLM 130 to generate an answer (e.g., extended answer 140) for the same prompt. Due to the edge LLM 116 being able to more quickly generate an answer to a prompt 112, XR system 100 is enabled to have edge LLM 116 generate edge answers 114 to less complex prompts 112 (e.g., prompts 112 requiring a less complex answer), generate an edge answer 114 while extended LLM 130 generates a more complex answer (e.g., an extended answer 140), or both.

As an example, in some embodiments, based on one or more input devices 104 receiving a user input that indicated a prompt 112, HWD 102 is configured to determine input data representing the text (e.g., question, direction, instruction) indicated in the prompt 112. Such input data, for example, includes a data structure (e.g., a matrix) that includes values representing the position and content of one or more letters, symbols (e.g., punctuation, characters), syllables, words, or sentences of the prompt 112. For example, in response to receiving a prompt 112, the edge LLM circuitry 110 of HWD 102 first generates one or more input tokens each including data representing at least a portion of the prompt 112 such as a letter, symbol, syllable, word, or sentence of the content (e.g., text) of the prompt 112. The edge LLM circuitry 110 then embeds each token by mapping the token to a corresponding vector that includes one or more values representing the content of the token. According to embodiments, the edge LLM circuitry 110 is configured to map a token to a corresponding vector based on the parameters 136 of the edge LLM 116 (e.g., based on the training data used to train the edge LLM 116). Further, after mapping each token to a corresponding vector (e.g., embedding), the edge LLM circuitry 110 then encodes each vector based on the position of the token mapped to the vector within the text of the prompt 112. That is to say, based on the position of a token within the text of a prompt 112, the edge LLM circuitry 110 encodes a corresponding vector such that the vector also includes data indicating the position of the token within the prompt 112. In some embodiments, the edge LLM circuitry 110 is configured to encode a vector to include such positional data using one or more sine functions, cosine functions, or both at one or more frequencies. After encoding each vector to include positional data (e.g., data indicating the position of a token within the prompt 112), the edge LLM circuitry 110 then combines the vectors to form a data structure (e.g., matrix) that forms the input data.

In embodiments, the edge LLM circuitry 110 then provides a respective portion of the input data (e.g., a respective portion of the matrix) to each attention layer 118 of the edge LLM 116. Based on the received portion of the input data, each attention layer 118 is configured to generate one or more tokens that each include data that represents at least a portion of an edge answer 114 such as a letter of an edge answer 114, a symbol of an edge answer 114, a syllable of an edge answer 114, a word of an edge answer 114, a sentence of an edge answer 114, a delegation to extended LLM 130 (e.g., a delegation token 142), an end token (e.g., a token indicating the end of a sentence, paragraph, or edge answer 114), or any combination thereof. To this end, each attention layer 118 includes a prefill phase and a decode phase. During a prefill phase of an attention layer 118, the edge LLM circuitry 110 first determines one or more queries, keys, and values based on the received portion of the input. As an example, the edge LLM circuitry 110 determines one or more matrices each having values representing weights based on corresponding parameters 136 of the edge LLM 116. The edge LLM circuitry then performs one or more matrix multiplication operations (e.g., scale dot products) using the determined matrices and the received portion of the input to determine one or more queries, keys, and values. Such queries, for example, each include a vector with values representing a corresponding token (e.g., letter, symbol, word, sentence) of the received portion of the input, such keys each include a vector with values representing descriptions of content potentially matching tokens represented by the portion of the received input, and such values each include a vector with values representing the content potentially matching tokens represented by the portion of the input. After generating these queries, keys, and values from the portion of the input, the edge LLM circuitry 110 builds a key-value cache which includes a data structure indicating the determined keys and values. Additionally, the edge LLM circuitry 110 performs one or more matrix multiplication operations using the determined queries, keys, and values to determine a first token. This first token, for example, represents a letter, symbol, word, or sentence of a first answer (e.g., edge answer 114) to be output to a user.

During a decode phase of each attention layer 118, the edge LLM circuitry 110 is configured to sequentially generate additional tokens based on the first token and key-value cache generated during the prefill phase. To this end, for a decode phase of an attention layer 118, the edge LLM circuitry 110 embeds the first token to produce an embedding that includes a vector having values indicating the first token. The edge LLM circuitry 110 then determines a query, key, and value by multiplying the determined embedding by one or more matrices each having values representing weights based on the parameters 136 of the edge LLM 116. After determining this query, key, and value, the edge LLM circuitry 110 performs one or more matrix multiplication operations using the determined query, the determined key, the determined value, one or more keys from the key-value cache, and one or more values from the key-value cache. Additionally, the edge LLM circuitry 110 updates the key-value cache to include the determined key and value. Based on these matrix multiplication operations, the edge LLM circuitry 110 determines a second token that includes data representing a second portion (e.g., letter, symbol, word, sentence) of an edge answer 114, a delegation token 142, or an end token. This delegation token 142, for example, includes data indicating that an extended answer 140 is to be generated in addition to the edge answer 114 being determined by the edge LLM 116. That is to say, the delegation token 142 indicates that an extended answer 140 generated by the extended LLM 130 is also required. Additionally, such an end token indicates the end of a sentence, the end of an edge answer 114, the end of token generation, or any combination thereof.

In embodiments, after generating a second token (e.g., a second token representing a second portion of an edge answer 114), during the decode phase of an attention layer 118, the edge LLM circuitry 110 generates a third token based on the second token. For example, the edge LLM circuitry 110 determines a query, key, and value from the second token and updates the key-value cache to include the determined key and value. The edge LLM circuitry 110 then performs matrix multiplication operations using the determined query, determined key, determined value, one or more keys from the key-value cache, and one or more values from the key-value cache to produce a third token representing a third portion of an edge answer 114, a delegation token 142, or an end token, or any combination thereof. The edge LLM circuitry 110 then continues to sequentially generate tokens in this manner until an end token is generated (e.g., an end token indicating the end of token generation), a predetermined condition is met (e.g., a predetermined number of tokens generated, a predetermined amount of time elapsed), or both. Once the LLM circuitry 116 has stopped generating tokens for each attention layer 118, the edge LLM circuitry 110 combines the generated tokens using, for example, a concatenate operation, to produce a first answer (e.g., edge answer 114). As an example, for each token generated by an attention layer 118, the edge LLM circuitry 110 is configured to determine an embedding (e.g., vector with values representing the token) via a linear transform based on the parameters 136 of the edge LLM 116. The edge LLM circuitry 110 then combines, via a concatenate operation, these embeddings to determine an output embedding and maps the output embedding to letters, symbols, words, sentences, or any combination thereof to generate an edge answer 114.

According to embodiments, the edge LLM circuitry 110 outputs this edge answer 114 to the user of the HWD 102 via a display 106, one or more output devices 108, or both. Such a display 106, in some embodiments, includes one or more light engines configured to output light representative of text indicated in the edge answer 114. Additionally, the display 106 includes an optical combiner having a lightguide configured to direct the light representing of text indicated in the edge answer 114 to the eye of the user such that the text indicated in the edge answer 114 is presented to the user in a real-world environment visible to the user through the optical combiner. Further, in other embodiments, the display 106 includes a light emitting diode (LED) display, liquid crystal display (LCD), organic light emitting diode (OLED) display, or any combination thereof configured to display the text indicated in the edge answer 114. Further, the one or more output devices 108 include one or more speakers, lights, or any combination thereof to output at least a portion of the edge answer 114. As an example, output devices 108 includes one or more speakers configured to output audio representing the text of an edge answer 114. In this way, HWD 102 is configured to generate and present an edge answer 114 (e.g., a first answer) to a user using the edge LLM 116. Due to the edge LLM 116 being smaller (e.g., having fewer parameters 136, fewer attention layers 118) than an LLM (e.g. extended LLM 130) implemented on one or more servers 126, the edge LLM 116 is able to more quickly generate and present an answer (e.g., edge answer 114) to a user than the LLM implemented on the servers 126. In light of this, the time (e.g., query time) from when the user enters a prompt via input devices 104 to when an answer is output to the user is reduced, helping to improve user experience.

However, because the edge LLM 116 is smaller than an LLM implemented on the servers 126, edge answers 114 generated by the edge LLM 116 are likely to be less complex, shorter, or both than answers generated by the LLM implemented on the servers 126. As such, situations arise when an additional answer (e.g., extended answer 140) is needed in addition to the edge answer 114 generated by the edge LLM 116. As such, in embodiments, after the edge LLM circuitry 110 has stopped generating tokens for each attention layer 118, edge LLM circuitry 110 is configured to determine if one or more delegation tokens 142 were generated for the attention layers 118. That is to say, edge LLM circuitry 110 determines whether the plurality of tokens generated using the edge LLM 116 indicate a second answer (e.g., extended answer 140) is to be generated. Based on one or more delegation tokens 142 being generated for the attention layers 118, the edge LLM circuitry 110 determines that an extended answer 140 generated by the extended LLM 130 is required (e.g., determines the plurality of tokens indicates a second answer is to be generated). To this end, edge LLM circuitry 110 transmits extended LLM input data 124 to the servers 126 via a network (e.g., local area network, wide area network, Internet, cellular network). This extended LLM input data 124, for example, includes data representing the prompt 112 that generated the delegation token 142, one or more tokens generated by the edge LLM 116 based on the prompt 112, one or more embeddings representing the generated tokens, or any combination thereof. As an example, in embodiments, the edge LLM circuitry 110 transmits the embeddings representing the tokens generated by the edge LLM 116 based on the prompt 112 to the servers 126 via the network.

Based on receiving extended LLM input data 124, servers 126 then generate an extended answer 140 using extended LLM 130. As an example, one or more servers 126 include an extended LLM circuitry 128 configured to implement extended LLM 130 so as to generate one or more extended answers 140. In response to receiving the extended LLM input data 124, the extended LLM circuitry 128 provides at least a portion of the extended LLM input data 124 to each attention layer 132 of the extended LLM 130. For example, the extended LLM circuitry 128 first determines positional data for each embedding indicated in the extended LLM input data 124. Such positional data, for example, indicates the position of a token represented by an embedding in an edge answer 114 generated by the edge LLM 116. The extended LLM circuitry 128 then provides data indicating one or more respective embeddings and corresponding positional data to each attention layer 132 of the extended LLM 130. According to embodiments, similar to the edge LLM 116, each attention layer 132 of extended LLM 130 is configured to generate one or more tokens based on the received portion of extended LLM input data 124. For example, each attention layer 132 includes a prefill phase and a second phase. During the prefill phase of an attention layer 132, the extended LLM circuitry 128, based on a received portion of extended LLM input data 124, determines one or more queries, keys, and values via, for example, one or more matrix multiplication operations using weights based on the parameters 138 of the extended LLM 130. Using these determined queries, keys, and values, the extended LLM circuitry 128 then generates a key-value cache and generates a first token by, for example, performing one or more additional matrix multiplication operations. This first token, as an example, includes data representing a portion (e.g., letter, symbol, word, sentence) of an extended answer 140.

During a decode phase of each attention layer 132, the extended LLM circuitry 128 sequentially generates additional tokens based on the first token generated during the prefill phase. For example, based on matrix multiplication operations using an embedding of the first token and weights corresponding to the parameters 138 of the extended LLM 130, the extended LLM circuitry 128 determines a query, key, and value for the first token. The extended LLM circuitry 128 then updates the key-value cache based on the determined key and value and performs one or more matrix multiplication operations using the determined query, determined key, determined value, and key-value cache to determine a second token. This second token, for example, represents a second portion of an extended answer 140 or an end token. For each attention layer 132, the extended LLM circuitry 128 continues generating tokens in this manner until an end token is generated, a predetermined condition (e.g., predetermined length of response, predetermined time elapsed) is met, or both. Once each attention layer 138 has finished generating tokens, the extended LLM circuitry 128 then combines the generated tokens to determine an extended answer 140. For example, the extended LLM circuitry 128 first determines embeddings for each of the generated tokens using one or more linear transforms based on the parameters 138 of the extended LLM 130. The extended LLM circuitry 128 then combines the embeddings and maps the combined embedding to letters, symbols, words, sentences, and the like forming the extended answer 140.

After determining the extended answer 140, the extended LLM circuitry 128 transmits, via the network, the extended answer 140 to the HWD 102. The HWD 102 then outputs a hybrid answer (e.g., an edge answer 114 and extended answer 140) to the user via display 106, output devices 108, or both. For example, concurrently with the display 106 displaying the text indicated in an edge answer 114, the HWD 102 displays the text indicated in the extended answer 140. That is to say, the display 106 is configured to concurrently display the edge answer 114 (e.g., a first answer) and the extended answer 140 (e.g., a second answer). As an example, an optical combiner of the HWD 102 is configured to direct light representative of the edge answer 114 and the extended answer 140 (e.g., representative of text of the edge answer 114 and the extended answer 140) such that the edge answer 114 and extended answer 140 are concurrently displayed. In this way, the HWD 102 is enabled to also present an extended answer 140 to a user when the edge LLM 116 determines that an extended answer 140 is required based on the prompt 112. As such, the HWD 102 is able to present more accurate and complex answers to prompts 112 in addition to an edge answer 114. Additionally, because the HWD 102 is configured to transmit extended LLM input data 124 to the servers 126, the extended LLM 130 does not need to determine these embeddings, reducing the time needed for the extended LLM 130 to generate an extended answer 140.

According to some embodiments, certain prompts include a complexity that does not allow for the edge LLM 116 to provide an adequate or desirable edge answer. As such, to help prevent the edge LLM 116 from generating edge answers that would not meet the criteria of a prompt 112, in embodiments, the edge LLM circuitry 110 is configured to compare a received prompt 112 to a predetermined prompt threshold 122. That is to say, based on receiving a prompt 112 via the input devices 104, the edge LLM circuitry 110 is configured to compare the prompt 112 to a predetermined prompt threshold 122. Such a predetermined prompt threshold 122 includes one or more predetermined values representing, for example, a threshold complexity of a prompt, a threshold length of a prompt, a threshold content of a prompt, or any combination thereof. In embodiments, the edge LLM circuitry 110 is configured to determine one or more values each representing a characteristic of the prompt 112 such as the complexity of the prompt 112, length (e.g., in letters, in words) of the prompt, the content of the prompt, or any combination thereof. As an example, the edge LLM circuitry 110 is configured to first generate and embed one or more tokens of the prompt 112 to produce embeddings (e.g., vectors) each including values representing at least a portion (e.g., letter, symbol, word, sentence) of the prompt 112. The edge LLM circuitry 110 then maps these embeddings, based on the parameters 136 of the edge LLM 116, to one or more complexity values, content values, or both. The edge LLM 116 then combines the determined complexity values, content values, or both to determine a complexity value, content value, or both for the prompt 112. After determining one or more values for the prompt 112, the edge LLM circuitry 110 then compares the determined values to the values indicated in the predetermined prompt threshold 122. Based on one or more values meeting or exceeding one or more values indicated by the predetermined prompt threshold 122, the edge LLM circuitry 110 transmits, via the network, data representing the prompt 112 to the servers 126 which then generate an answer based on the prompt 112 using the extended LLM 130. In this way, the edge LLM circuitry 110 is configured to bypass the edge LLM 116 when one or more values of the prompt 112 meet or exceed values indicated by the predetermined prompt threshold 122.

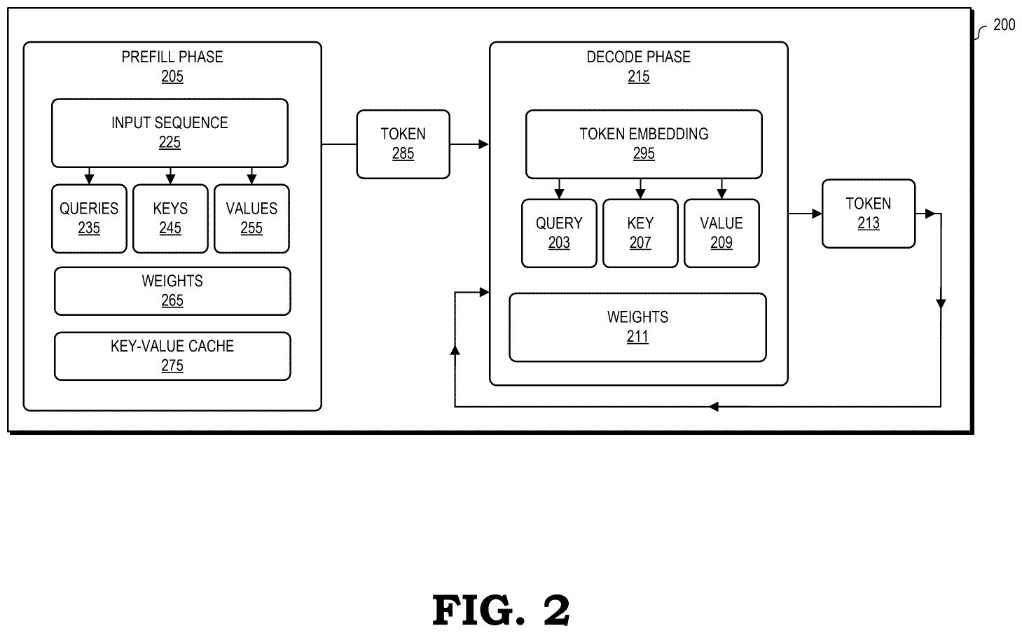

Referring now to FIG. 2, an example attention layer 200 for an LLM is presented. In embodiments, HWD 102 is configured to implement example attention layer 200 as one or more attention layers 118 of edge LLM 116 (e.g., a first LLM), one or more servers 126 are configured to implement example attention layer 200 as one or more attention layers 132 of extended LLM 130 (e.g., a second LLM), or both. In embodiments, example attention layer 200 is implemented by an LLM circuitry (e.g., edge LLM circuitry 110, extended LLM circuitry 128) configured to generate one or more tokens 285, 213 based on received input data (e.g., input sequence 225). This input sequence 225, for example, represents at least a portion of a prompt 112, one or more embeddings from an edge LLM 116 (e.g., extended LLM input data 124), or both. As an example, in some embodiments, the LLM circuitry implementing example attention layer 200 is configured to first determine one or more tokens each including data representing at least a portion of a prompt 112 (e.g., a letter, symbol, word, or sentence of the prompt 112). The LLM circuitry then generates an embedding (e.g., input token embedding) for each token by performing a linear transformation based on one or more weights determined from the parameters (e.g., parameters 136, 138) of the LLM including the example attention layer 200. The LLM circuitry then encodes these input token embeddings based on the positional data of the tokens within the prompt 112 such that each embedding includes values representing a corresponding token and values representing the position of the token within the prompt 112. The LLM circuitry then provides one or more of these encoded embeddings to the example attention layer 200 as input sequence 225. As another example, according to some embodiments, the LLM circuitry (e.g., extended LLM circuitry 128) implementing example attention layer 200 is configured to receive one or more embeddings each representing a token generated by edge LLM 116. That is to say, embeddings of tokens together representing an edge answer 114 produced by edge LLM 116. The LLM circuitry then encodes these embeddings with positional data of the generated tokens within the edge answer 114 such that each embedding includes values representing a token of the edge answer 114 and the position of the token within the edge answer 114. The LLM circuitry the provides one or more of these embeddings to example attention layer 200 as input sequence 225.

To generate one or more tokens from input sequence 225, example attention layer 200 includes a prefill phase 205 and a decode phase 215. During the prefill phase 205, the LLM circuitry determines one or more queries 235, keys 245, and values 255 based on the input sequence 225. As an example, using the input sequence 225 and one or more or more matrices each including corresponding weights 265 based on the parameters (e.g., parameters 136, 138) of the LLM including example attention layer 200, the LLM circuitry performs one or more matrix multiplication operations (e.g., scale dot product operations) to determine one or more queries 235, keys 245, and values 255. These queries 235, for example, each include a vector with values representing a portion of the content (e.g., letter, symbol, word, sentence) of the input sequence 225, the keys 245 each include a vector with values describing portions of content (e.g., letter, symbol, word, sentence) potentially matching the input sequence 225, and the values 255 each include vectors with values representing the content potentially matching the input sequence 225. After determining these queries 235, keys 245, and values 255, the LLM circuitry generates a key-value cache 275 that includes the generated keys 245 and values 255.

Further, using the determined queries 235, keys 245, and values 255, the LLM circuitry performs one or more matrix multiplication operations to determine a token 285 representing at least a portion (e.g., letter, symbol, word, sentence) of an answer (e.g., edge answer 114, extended answer 140) to the input sequence 225. During the decode phase 215 of the example attention layer 200, the LLM circuitry sequentially generates tokens (e.g., token 213) based on the token 285 generated during the prefill phase 205. For example, based on the token 285, the LLM circuitry determines a token embedding 295 that includes a vector with values representing the token. To produce the token embedding 295, the LLM circuitry is configured to, for example, perform a linear transform of the token 285 based on one or more weights of the LLM determined from the parameters of the LLM. The LLM circuitry then performs one or more matrix multiplication operations using the token embedding 295 and one or more matrices of weights 211 determined from the parameters of the LLM to generate a query 203, key 207, and value 209. Such a query 203 includes a vector with values representing the content of token 285, the key 207 includes a vector with values describing content potentially matching the token 285, and the value 209 includes a vector with values representing the content potentially matching the token 285.

After generating the query 203, key 207, and value 209, the LLM circuitry then updates the key-value cache 275 to include the key 207 and the value 209. Additionally, the LLM circuitry performs one or more matrix multiplication operations using the query 203, key 207, value 209, one or more keys from key-value cache 275, and one or more values from key-value cache 275 to determine token 213. Token 213, for example, includes data representing at least a portion (e.g., letter, symbol, words, sentence) of an answer (e.g., edge answer 114, extended answer 140) to the input sequence 225, a delegation token 142, or an end token. In embodiments, after generating token 213, the LLM circuitry generates a subsequent token embedding 295 for token 213, generates a query 203, key 207, and value 209 for this token embedding 295, and updates the key-value cache 275 as described above. Based on this query 203, key 207, value 209, and updated key-value cache 275, the LLM circuitry then generates a subsequent token. The LLM circuitry then continues in this way until an end token is generated, a predetermined condition (e.g., a predetermined number of tokens generated, a predetermined amount of time elapsed) occurs, or both. Once the LLM circuitry stops generating tokens for the example attention layer 200, the LLM circuitry then combines (e.g., via a concatenate function) the tokens generated on each example attention layer 200 of an LLM to determine an answer (e.g., edge answer 114, extended answer 140).

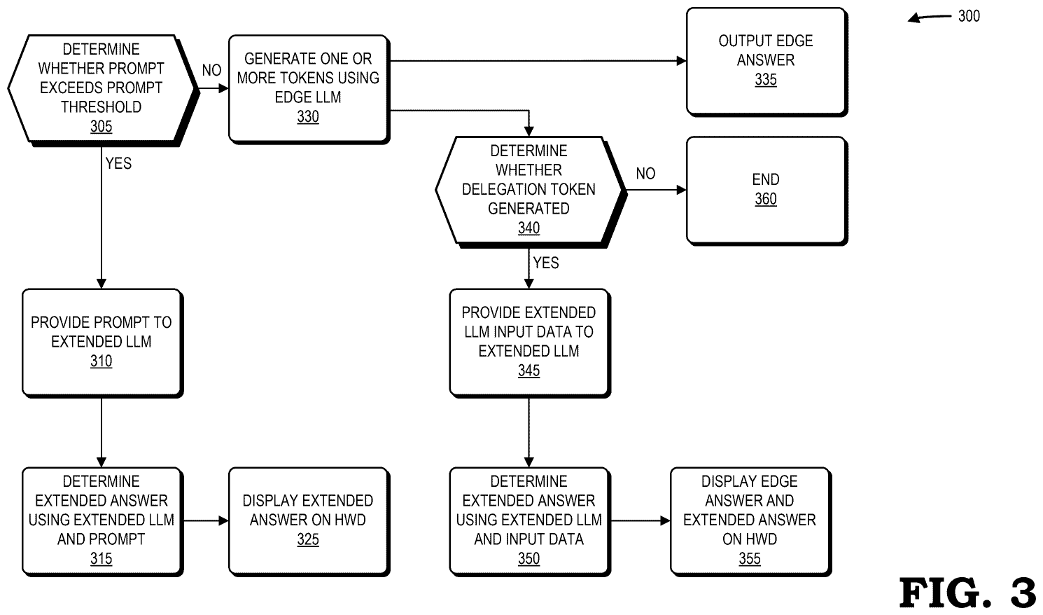

Referring now to FIG. 3, an example operation 300 for providing an answer to a prompt using an edge LLM (e.g., a first LLM) and extended LLM (e.g., a second LLM) is provided, in accordance with some embodiments. In embodiments, example operation 300 is implemented at least in part by HWD 102 and one or more servers 126. According to embodiments, example operation 300 first includes, at block 305, one or more input devices 104 of HWD 102 receiving a prompt 112. Further still at block 305, the example operation 300 includes edge LLM circuitry 110 determining whether the received prompt 112 meets or exceeds prompt threshold 122 (e.g., exceed a predetermined threshold). That is to say, whether the complexity, length, content, or any combination thereof of the received prompt 112 meets or exceeds one or more values indicated in the prompt threshold 122. To make such a determination, in embodiments, the edge LLM circuitry 110 is configured to determine one or more values representing the complexity, length, content, or any combination thereof of the prompt 112. As an example, the edge LLM circuitry 110 first determines one or more tokens each including data representing at least a portion of the prompt 112 such as a letter, symbol, word, or sentence. The edge LLM circuitry 110 then maps these tokens, via a linear transform, to one or more content values, complexity values, or both based on the parameters 136 of the edge LLM circuitry 110 (e.g., based on weights determined from the parameters 136) and compares these content values and complexity values to corresponding values indicated in the prompt threshold 122. Based on the length, complexity value, content value, or any combination thereof meeting or exceeding one or more corresponding values indicating the prompt threshold 122, the edge LLM circuitry 110, at block 310, transmits, via a network, data representing the prompt 112 to one or more servers 126.

Based on receiving the data representing the prompt 112, at block 315, an extended LLM circuitry 120 of the servers 126 generates an extended answer 140 to the prompt 112 using extended LLM 130. For example, the extended LLM circuitry 120 first generates one or more input sequences 225 based on the prompt 112 and provides a respective input sequence 225 to each attention layer 132 of the extended LLM 130. Each attention layer 132 then generates one or more tokens which the extended LLM circuitry 128, via a concatenate function, combines together to generate an extended answer 140. The servers 126 then transmit the extended answer 140 back to the HWD 102 via the network. In response to receiving the extended answer 140, at block 325, the HWD 102 then outputs the text indicated in the extended answer using display 106, one or more output devices 108, or both. Referring again to block 305, based on the length, complexity value, or content value, or any combination thereof not meeting or exceeding one or more corresponding values indicating the prompt threshold 122, the edge LLM circuitry 110, at block 330, generates one or more tokens based on the prompt 112 using edge LLM 116. As an example, based on the prompt 112, edge LLM circuitry 110 generates one or more input sequences 225 based on the prompt 112 and provides a respective input sequence 225 to each attention layer 118 of the edge LLM 116. For each attention layer 132, the edge LLM circuitry 110 then generates one or more tokens (e.g. tokens 213) each representing a respective portion of an edge answer 114, a delegation token 142, or an end token. The edge LLM circuitry 110 then combines the generated tokens to produce an edge answer 114 (e.g., a first answer), for example, using a concatenate operation. The HWD 102 then, at block 335, outputs the edge answer 114 to the user via the display 106, one or more output devices 108, or both. As an example, the HWD 102 outputs the text of the edge answer 114 on display 106 such that the text of the edge answer 114 is presented to the user in a real-world environment visible through the HWD 102.

Further, concurrently with outputting the edge answer 114, at block 340, the edge LLM circuitry 110 is configured to determine whether one or more attention layers 118 of the edge LLM 116 has generated one or more delegation tokens 142. That is to say, whether one or more attention layers 118 of the attention layers 118 generated at least one token indicating that an extended answer 140 (e.g., a second answer) is to be generated. Based on determining that no delegation token 142 was generated by the attention layers 118, at block 360, the edge LLM 116 ends example operation 300. Further, based on determining that one or more delegation tokens 142 were generated by the attention layers 118, at block 345, the edge LLM circuitry 110 transmits extended LLM input data 124 to one or more servers 126 implementing extended LLM 130. That is to say, example operation 300 includes edge LLM circuitry 110 transmitting data representing the tokens generated by edge LLM 116. As an example, the edge LLM circuitry 110 transmits, via a network, one or more embeddings representing the tokens (e.g., tokens 213) generated by the attention layers 118 of the edge LLM 116 to the servers 126 implementing extended LLM 130. After receiving the extended LLM input data 124, at block 350, the extended LLM circuitry 128 of one or more servers 126 is configured to generate an extended answer 140 based on the extended LLM input data 124 using extended LLM 130.

As an example, the extended LLM circuitry 128 first determines one or more input sequences 225 based on the extended LLM input data and provides a respective input sequence 225 to each attention layer 132 of the extended LLM 130. The extended LLM circuitry 128, for each attention layer 132, then generates one or more tokens which the extended LLM circuitry 128, via a concatenate function, combines to generate an extended answer 140. The servers 126 then transmit the extended answer 140 back to the HWD 102 via the network. At block 355, based on receiving the extended answer 140, the HWD 102 then outputs the extended answer 140 to the user via display 106, one or more output devices 108, or both so as to output a hybrid answer (e.g., an edge answer 114 and extended answer 140). As an example, concurrently with displaying an edge answer 114 to a user, the HWD 102 displays the extended answer 140 to the user via display 106 such that the text indicated in both the extended answer 140 and edge answer 114 is concurrently presented in a real-world environment visible to the user through the HWD 102.

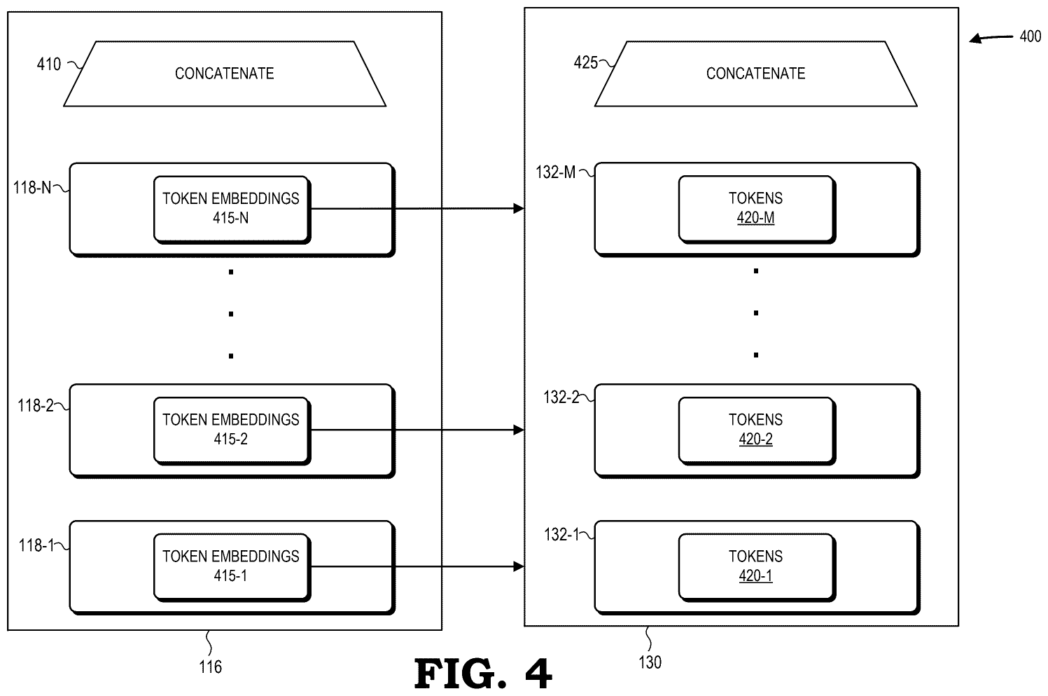

Referring now to FIG. 4, an example operation 400 for providing an extended LLM input to an extended LLM is presented, in accordance with embodiments. In embodiments, example operation is implemented in XR system 100 by edge LLM circuitry 110 and extended LLM circuitry 128. According to embodiments, example operation 400 includes the edge LLM circuitry 110, for each attention layer 118 of edge LLM 116, generating one or more tokens (e.g., token 213) based on a prompt 112. Each generated token, for example, represents at least a portion (e.g., letter, symbol, word, sentence) of an edge answer 114 (e.g., a first answer). Though the example embodiment presented in FIG. 4 shows edge LLM 116 as including three attention layers 118-1, 118-2, 118-N representing an N number of attention layers, in other embodiments, edge LLM 116 can include any number of attention layers.

Once the edge LLM circuitry 110 has finished generating a token for each attention layer 118 based on the prompt, the edge LLM circuit then combines the generated token via a concatenate operation 410 to generate an edge answer 114. For example, for each token generated for the attention layers 118, the edge LLM circuitry 110 determines a corresponding token embedding. That is to say, for each attention layer 118 of the edge LLM 116, the edge LLM circuitry 110 determines a respective set of token embeddings (415-1, 415-2, 415-N) based on the tokens generated for the attention layer 118. Each token embedding includes a vector having values representing the content (e.g., letter, symbol, words, sentence) of a corresponding token. To determine these sets of token embeddings 415, for each generated token, the edge LLM circuitry 110 maps the generated token to a corresponding token embedding using a linear transform based on weights determined from the parameters 136 of the edge LLM 116. After determining a set of token embeddings 415 for each attention layer 118, the edge LLM circuitry 110 then performs the concatenate operation 410 to combine the sets of token embeddings 415 to generate an output embedding. The edge LLM circuitry 110 next maps this output embedding to one or more letters, symbols, words, sentences, and the like using a linear transform to determine an edge answer 114.

According to embodiments, example operation 400 includes the edge LLM circuitry 110 generating one or more delegation tokens 142 based on the prompt 112. Based on generating one or more delegation tokens 142 (e.g., based on one or more tokens indicating a second answer is to be generated), the edge LLM circuitry 110 is configured to transmit, via a network, the generated sets of token embeddings 415 to one or more servers 126 implementing extended LLM 130. That is to say, example operation 400 includes the edge LLM circuitry 110 transmitting token embeddings 415 to the one or more servers 126 as extended LLM input data 124. In response to receiving these sets of transmitted token embeddings 415, the extended LLM circuitry 128 of the one or more servers 126 then provides respective transmitted token embeddings of the received sets of token embeddings 415 each to corresponding attention layers 132 of the extended LLM 130. For each attention layer 132, the extended LLM circuitry 128 then generates a set of one or more tokens 420 based on corresponding token embeddings provided to the attention layer 132. Each of these sets of tokens 420, for example, represents at least a portion (e.g., letter, symbol, word, sentence) of an extended answer 140, an end token, or both. Though the example embodiment presented in FIG. 4 shows extended LLM 130 as including three attention layers (132-1, 132-2, 132-M) representing an M number of attention layers 132 each generating a set of tokens (420-1, 420-2, 420-M) in other embodiments, extended LLM 130 can include any number of attention layers 132 each configured to generate a set of one or more tokens 420. Additionally, the number of attention layers 132 of extended LLM 130 is greater than the number of attention layers 118 of edge LLM 116.

Once the extended LLM circuitry 128 has completed generating a set of one or more tokens 420 for each attention layer 132, the extended LLM circuitry 128 then combines all the generated tokens via a concatenate operation 425 to produce an extended answer 140. For example, the extended LLM circuitry 128 first determines a corresponding embedding for each token generated by performing a linear transform based on the parameters 138 of the extended LLM 130. The extended LLM circuitry 128 then combines these embeddings to determine an output embedding via the concatenate operation 425. Further, the extended LLM circuitry 128 maps this output embedding, via a linear transform, to one or more letters, symbols, words, or sentences to produce an extended answer 140.

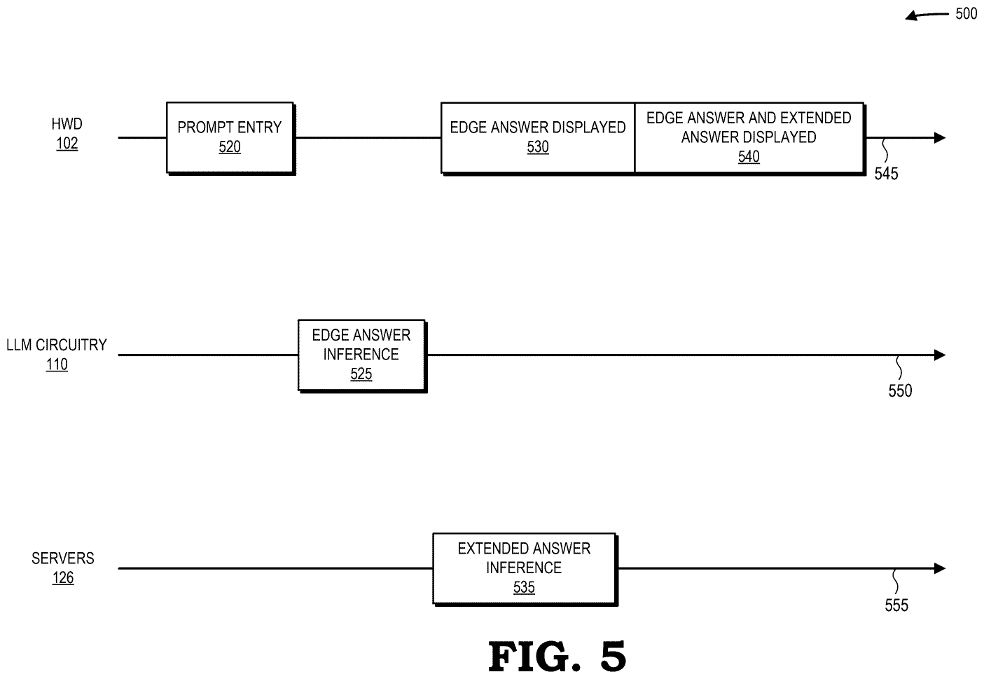

Referring now to FIG. 5, an example timing diagram 500 for providing an answer to a user using an edge LLM and an extended LLM, in accordance with some embodiments. In embodiments, example timing diagram 500 includes three axes 545, 550, and 555 each representing the same amount of time elapsed. Further axis 545 represents the amount of time elapsed for an HWD 102, axis 550 represents the amount of time elapsed for an edge LLM circuitry 110, and axis 555 represents the amount of time elapsed for one or more servers 126. According to embodiments, example timing diagram 500 first shows HWD 102 receiving a prompt entry 520 that represents one or more input devices 104 of HWD 102 receiving user inputs representing a prompt 112. After HWD 102 has received the user input representing the prompt 112, the edge LLM circuitry 110 begins to determine an edge answer 114 based on the prompt 112, represented in FIG. 5 as edge answer inference 535. During edge answer inference 525, the edge LLM circuitry 110 generates one or more tokens based on the prompt 112 and combines these tokens to produce an edge answer 114.

After the edge LLM circuitry 110 produces edge answer 114, the HWD 102 presents the edge answer 114 to the user via, for example, display 106. Outputting the edge answer 114 to the user using display 106 is represented in FIG. 5 as edge answer displayed 530. As demonstrated by example timing diagram 500, concurrently with HWD 102 displaying the edge answer 114, one or more servers 126 are configured to generate an extended answer 140 using extended LLM 130. For example, based on extended LLM input data 124 received from HWD 102, the servers 126 generate one or more tokens for each attention layer 132 of the extended LLM 130 based on the extended LLM input data 124. The servers 126 then combine these tokens to produce an extended answer 140. Once servers 126 have produced the extended answer 140, the servers 126 then transmit, via a network, the extended answer 140 to the HWD 102 which outputs a hybrid answer including the edge answer 114 and the extended answer 140 to the user via, for example, the display 106. As an example, concurrently with displaying the edge answer 114, the HWD 102 displays the extended answer 140 using display 106. Concurrently displaying the edge answer 114 and extended answer 140 is represented in FIG. 5 by edge answer and extended answer displayed 540.

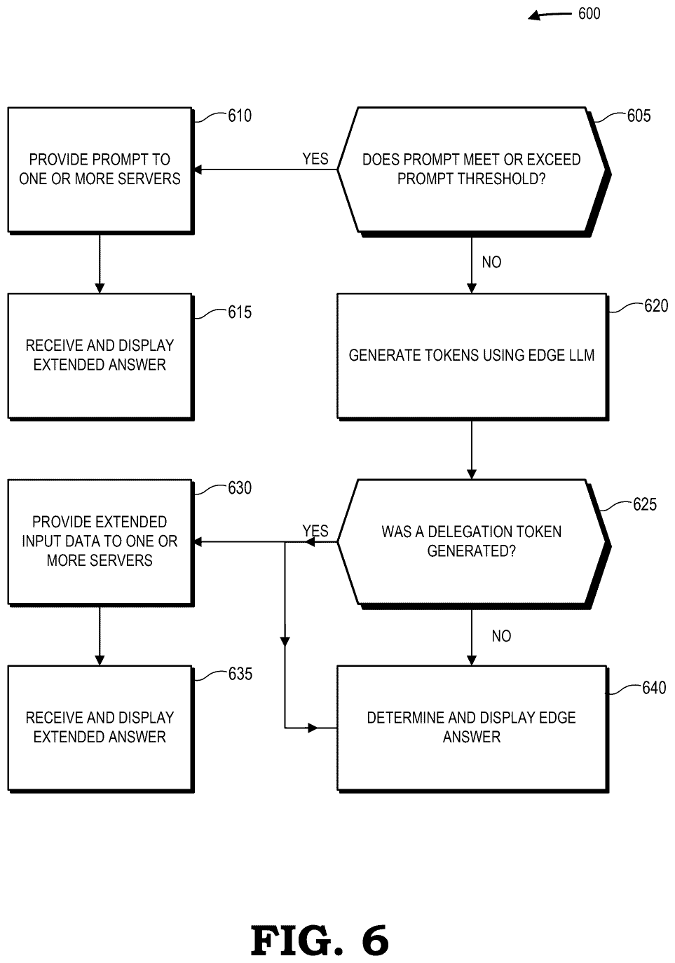

Referring now to FIG. 6, an example method 600 for producing a hybrid answer using an edge LLM and extended LLM is presented, in accordance with some embodiments. In embodiments, example method is implemented by HWD 102. According to embodiments, example method 600 first includes, at block 605, HWD 102 receiving one or more user inputs representing a prompt 112. Based on receiving the prompt 112, HWD 102 then determines whether the prompt 112 meets or exceeds a predetermined prompt threshold 122. As an example, based on data indicated in the prompt 112, one or more linear transforms, or both, HWD 102 determines one or more values for the prompt 112 representing the complexity of the prompt 112, the content of the prompt 112, the length of the prompt (e.g., in letters, words, sentences) or any combination thereof. The HWD 102 then compares these determined values of the prompt 112 to one or more values indicated in the predetermined prompt threshold 122. In response to one or more values of the prompt 112 meeting or exceeding one or more values indicated in the predetermined prompt threshold 122, at block 610, the HWD 102 then transmits, via a network, data representing the prompt 112 to one or more servers 126 implementing extended LLM 130. Using the prompt 112 and extended LLM 130, the servers 126 generate an answer (e.g., extended answer 140) and transmit, via the network, the answer to the HWD 102. After receiving the answer from the servers 126, at block 615, the HWD 102 then outputs the answer to the user via display 106, one or more output devices 108, or both. As an example, HWD 102 displays the text indicated in the answer on display 106 such that the text is visible in a real-world environment visible to the user through the HWD 102.

Referring again to block 605, based on the determined values (e.g., complexity, content, length) for the prompt 112 not meeting or exceeding the values indicated by the predetermined prompt threshold 122, at block 620, HWD 102 generates one or more tokens (e.g., tokens 213) based on the prompt 112 and the edge LLM 116. For example, HWD 102 first provides respective data (e.g., input sequence 225) representing at least a portion of the prompt 112 to each attention layer 118 of the edge LLM 116. For each attention layer 118 of the edge LLM 116, HWD 102 then generates one or more tokens based on a corresponding input sequence 225 and the weights (e.g., weights 211, 265) of the edge LLM 116. Each of these generated tokens, for example, represents a portion (e.g., letter, symbol, words, sentence) of an edge answer 114, a delegation token 142 (e.g., a token indicating an extended answer 140 is required), or an end token. At block 625, HWD 102 then determines whether the HWD 102 generated one or more delegation tokens 142 for one or more attention layers 118 of the edge LLM 116. However, regardless of whether the HWD 102 generated one or more delegation tokens 142 for one or more attention layers 118 of the edge LLM 116, at block 640, HWD 102 determines an edge answer 114 based on the generated tokens. For example, for one or more of the tokens generated for the attention layers 118, HWD 102 determines a token embedding (e.g., token embedding 415) that includes a vector with values representing the token. HWD 102 then combines these token embeddings via a concatenate operation (e.g., concatenate operation 410) to determine an output embedding and maps this output embedding to the edge answer 114 using one or more linear transforms based on the parameters 136 of the edge LLM 116. After determining the edge answer 114, HWD 102 outputs the edge answer 114 to the user via, for example, display 106, one or more output devices 108, or both. As an example, HWD 102 displays the text indicated in the edge answer 114 on display 106 such that the text is visible in a real-world environment visible to the user through the HWD 102.

Additionally, referring again to block 625, based on HWD 102 having generated one or more delegation tokens 142, at block 630, HWD 102 transmits, via a network, extended LLM input data 124 to the servers 126 implementing the extended LLM 130. As an example, HWD 102 transmits token embeddings (e.g., token embeddings 415) representing the tokens generated by the edge LLM 116 to the servers 126. After receiving the extended LLM input data 124, the servers 126 then generate an extended answer 140 based on the extended LLM input data 124 and the extended LLM 130. For example, the servers 126 first provide a respective portion (e.g., respective token embeddings) of the extended LLM input data 124 to each attention layer 132 of the extended LLM 130. For each attention layer 132, the servers 126 generate one or more tokens (e.g., tokens 420) based on a corresponding portion of the extended LLM input data 124 and the weights of the extended LLM 130. The servers 126 then combine these generated tokens to produce an extended answer 140. Further, the servers 126 transmit this extended answer 140, via the network, to the HWD. According to some embodiments, HWD 102 is configured to perform blocks 630 and 640 concurrently. In response to receiving the extended answer 140 from the servers 126, HWD 102, at block 635, is configured to output a hybrid answer that includes the edge answer 114 and the extended answer 140 to the user via display 106, one or more output devices 108, or both. As an example, HWD 102 displays the text indicated in the extended answer 140 on display 106 such that the text is visible in a real-world environment visible to the user through the HWD 102 concurrently with the text of the edge answer 114.

In some embodiments, certain aspects of the techniques described above may be implemented by one or more processors of a processing system executing software. The software comprises one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium may be in source code, assembly language code, object code, or other instruction format that is interpreted or otherwise executable by one or more processors.

A computer-readable storage medium may include any storage medium, or combination of storage media, accessible by a computer system during use to provide instructions and/or data to the computer system. Such storage media can include but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
based on receiving a prompt at a device, generating, by a first large language model implemented at the device, a plurality of tokens and a first answer;
displaying the first answer on the device;
based on at least one token of the plurality of tokens indicating a second answer is to be generated, transmitting data representing the plurality of tokens to a second large language model different from the first large language model; and
displaying, on the device, the second answer received from the second large language model.

2. The method of claim 1, further comprising:
generating, by the second large language model, tokens for one or more layers of the second large language model based on the data representing the plurality of tokens; and
combining the tokens for the one or more layers to produce the second answer.

3. The method of claim 1, wherein generating the plurality of tokens includes:
determining a plurality of input tokens based on the prompt;
embedding the plurality of input tokens to produce a plurality of input token embeddings; and
producing one or more inputs for the first large language model based on the plurality of input token embeddings.

4. The method of claim 3, wherein generating the plurality of tokens includes:
for each attention layer of the first large language model, generating one or more tokens of the plurality of tokens based on a corresponding input of the one or more inputs; and
combining the plurality of tokens to produce the first answer.

5. The method of claim 1, wherein the first large language model includes a number of attention layers fewer than a number of attention layers of the second large language model.

6. The method of claim 1, wherein the data representing the plurality of tokens includes one or more token embeddings representing the plurality of tokens.

7. The method of any of claim 1, wherein displaying the second answer comprises displaying the second answer within a real-world environment visible through the device.

8. The method of claim 1, further comprising:
based on a complexity or length of the prompt meeting or exceeding a predetermined threshold, bypassing the first large language model such that the plurality of tokens is not generated.

9. The method of claim 8, wherein bypassing the first large language model includes:
transmitting, to the second large language model, data representing the prompt; and
based on transmitting data representing the prompt, displaying an answer received from the second large language model.

10. A device, comprising:
an input device configured to receive a prompt;
a large language model circuitry configured to:
generate, by a first large language model, a plurality of tokens and a first answer based on the prompt; and
based on at least one token of the plurality of tokens indicating a second answer is to be generated, transmit data representing the plurality of tokens to a second large language model different from the first large language model; and
a display configured to display the first answer and the second answer received from the second large language model.

11. The device of claim 10, wherein the display is configured to concurrently display the first answer and the second answer in a real-world environment visible through the device.

12. The device of claim 10, wherein the display comprises an optical combiner configured to direct light representative of the first answer and the second answer.

13. The device of claim 10, wherein the first large language model has a smaller memory footprint than the second large language model.

14. The device of claim 10, wherein the large language model circuitry is configured to:
determine a plurality of input tokens based on the prompt;
embed the plurality of input tokens to produce a plurality of input token embeddings; and
produce one or more inputs for the first large language model based on the plurality of input token embeddings.

15. The device of claim 14, wherein the large language model circuitry is configured to:
for each attention layer of the first large language model, generate one or more tokens of the plurality of tokens based on a corresponding input of the one or more inputs; and
combine the plurality of tokens to produce the first answer.

16. A non-transitory computer-readable storage medium including instructions that, when executed by at least one processor of a device, cause the at least one processor to:
based on receiving a prompt at a device, generate, by a first large language model implemented at the device, a plurality of tokens and a first answer;
display the first answer on the device;
based on at least one token of the plurality of tokens indicating a second answer is to be generated, transmit data representing the plurality of tokens to a second large language model different from the first large language model; and
display, on the device, the second answer received from the second large language model.

17. The non-transitory computer-readable storage medium of claim 16, further including instructions that, when executed by the at least one processor, cause the at least one processor to:
determine a plurality of input tokens based on the prompt;
embed the plurality of input tokens to produce a plurality of input token embeddings; and
produce one or more inputs for the first large language model based on the plurality of input token embeddings.

18. The non-transitory computer-readable storage medium of claim 17, further including instructions that, when executed by the at least one processor, cause the at least one processor to:
for each attention layer of the first large language model, generate one or more tokens of the plurality of tokens based on a corresponding input of the one or more inputs; and
combine the plurality of tokens to produce the first answer.

19. The non-transitory computer-readable storage medium of claim 16, further including instructions that, when executed by the at least one processor, cause the at least one processor to:
display the first answer on the device concurrently with transmitting the data representing the plurality of tokens.

20. The non-transitory computer-readable storage medium of claim 16, further including instructions that, when executed by the at least one processor, cause the at least one processor to:
based on a complexity or length of the prompt meeting or exceeding a predetermined threshold, bypassing the first large language model such that the plurality of tokens is not generated.
